(19) United States
(12) Patent Application Publication
(10) Pub. No.: US 2020/0321708 A1
(43) Pub. Date: Oct. 8, 2020

(54) Ultra-wideband Modular Tightly Coupled Array Antenna

(71) Applicant: Phase Sensitive Innovations, Inc., Newark, DE (US)

(72) Inventors: Shouyuan Shi, Newark, DE (US); Dennis Prather, Newark, DE (US); Brandon Stacy, Newark, DE (US)

(21) Appl. No.: 16/843,798

(22) Filed: Apr. 8, 2020

Related U.S. Application Data
(60) Provisional application No. 62/830,642, filed on Apr. 8, 2019.

(51) Int. Cl. H01Q 21/00; H01Q 9/04; H01Q 5/364; H01Q 23/00

(52) U.S. Cl. CPC H01Q 21/0025; H01Q 23/00; H01Q 5/364; H01Q 9/0407

(57) ABSTRACT

A modular-based tightly coupled array comprises a plurality of antenna unit cells, each antenna unit cell having a pair of radiating arms and a connected RF feed configured to feed an RF signal to the pair of radiating arms, each pair of radiating arms and RF feed of each antenna unit cell integrated as part of a corresponding printed circuit board (PCB). The antenna unit cells may be positioned above a conductive ground plane and connected to a plurality of RF connectors mounted to the conductive ground plane.

### CROSS-REFERENCE TO RELATED APPLICATION

This application is a nonprovisional of U.S. provisional application No. 62/830,642, filed on Apr. 8, 2019, the disclosure of which is incorporated herein in its entirety by reference.

### BACKGROUND

The emergence of 5G technologies is driving the need for antenna systems with advanced beam forming capabilities. While FCC has released new bands in the millimeter wave (mmW) region of the spectrum, there is still significant in developing such capabilities in existing cellular infrastructures, namely those the current frequency spectrum which extend from 700 MHz to 6 GHz. This lower frequency range of operation offers large geographic coverage with relatively lower powers. In addition, the increased use of massive MIMO further motivates phased array technologies in this spectral range. In so doing, large numbers of array antennas located at cellular base stations can significantly help mitigate interference issues often occurred in the lower frequency spectrum. Moreover, such technology also offers the capability to simultaneously serve multiple users in densely populated areas. However, there remains a challenge for the widespread use of such phased arrays, which is the development of ultra-wideband (UWB) sub-6 GHz operation.

To make UWB technology effective for the sub-6 GHz spectrum, i.e., 700 MHz to 6 GHz, there are several technical challenges that need to be addressed. One such challenge is the design of good and suitable UWB antenna elements and their corresponding arrays. In particular, design specifications including low VSWR over the interested frequency bandwidth, i.e., <1.5 at the bore side, large beam scan ability with a field-of-the-regard of over ±45°, dual linear polarization, low cross polarization of less than −25 dB, low side lobes of less than −15 dB, and high front-to-back ratio of great than 20 dB. In addition, a low profile design is preferred.

The design of such an UWB phased array antenna is challenging, especially over a large field-of-regard. In this case, to mitigate grating lobes, which can appear within the field-of-regard, the pitch of the antenna elements, within the array, must be less than one-half wavelength at the highest operational frequency. As a result, the electrical length of the radiating elements becomes extremely sub-wavelength, i.e., one-sixteenth at the longest wavelength for an 8:1 operational bandwidth. In a typical UWB analysis, the antenna bandwidth is defined as the ratio of the highest frequency f_{high} to the lowest frequency of the interested frequency band f_{low}, i.e., f_{high}/f_{low}. In order to meet the requirement of field-of-regard, there are a few dense ultra-wideband array antennas that have been considered, such as tightly coupled dipole arrays and strongly coupled tapered slot arrays. Since the electrical size of the antenna element is less than one-half wavelength at the highest operational frequency, these antennas typically have a larger half-power beam width (HPBW), i.e., greater than ±45 degrees. Therefore, these antenna arrays can be used to form an array that has a large beam steering range without introducing grating lobes during scanning. However, due to the small electrical size of each element, the gain of each radiating element varies significantly over the range of operational frequencies.

To recap, the historical development of UWB dense arrays is summarized in FIG. 1, which shows a some of the more popular UWB arrays. Here, some of the elements more suitable for UWB arrays are tapered slot antenna (TSA), balanced antipodal Vivaldi antenna (BAVA), low-profile bunny-ear antenna, planar ultrawideband modular antenna (PUMA), substrate free frequency scaled UWB spectrum element (FUSE), and current sheet antenna (CSA), tightly coupled dipoles, and spirals.

As discussed more fully below, each of these has pros and cons. A Vivaldi TSA array is easy to feed, but has a high-profile and high cross-polarization. Bunny ear antennas are easy to feed and have a low profile and low cross-polarization, but are non-planar and employ Baluns. A BAVA is easy to feed and has a low profile and low cross-polarization, but is non-planar and employs Baluns. A PUMA has a low profile, low cross-polarization, an unbalanced feed. A FUSE has a lower profile and low cross-polarization, but employs Baluns. A TSA is planar and has a low-profile and low cross-polarization, but employs external Baluns. A spiral array is planar and has a lower profile, but has a circular polarization. A fragment array is planar and has a low profile, but has high cross-polarization.

Initially, the TSA is one of the first generation of UWB arrays and achieves wide bandwidth performance by virtue of being a traveling wave antenna. This array can be readily fabricated and fed by microstrip-lines or strip-lines. In most cases, a TSA array operates over a frequency band for which their tapered slots are longer than half a wavelength at the low end of the frequency band and are larger than two wavelengths at the high end for a typical ratio of 3:1 bandwidth. For dense array applications, the aperture of each element has a size of one-half wavelength at the highest frequency. In order to improve the impedance bandwidth beyond 3:1, a longer taper slot should be used. In comparison, the TSA has several drawbacks, such as high profile, potentially high-order modal excitation, and high cross-polarization coupling. As a result, vertical currents running along the slot's length along the high profile can cause high cross-polarized radiation when scanning. Using a BAVA, FUSE, or bunny-ear antenna array can mitigate these drawbacks.

The conventional TSA and Vivaldi antennas exhibit high cross polarization, particularly when a thick and high dielectric constant substrate is used. To improve the cross polarization performance, balanced antipodal Vivaldi antennas (BAVA) are proposed. In the application to the array, high dielectric substrate is required to reduce the wavelength in the material in order to lower the cutoff frequency. This, however, increases the aperture of the BAVA over one wavelength in the material, leading to reduced gain at the highest frequency. Progresses, such as doubly mirrored BAVA, increased inter-radiator coupling, have been made to further increase the operational bandwidth, i.e., >10:1, and reduce the profile to about λ/2 at the highest frequency. In the bunny-ear design, both the inner and outer edges of bunny-ear antennas are flared. The radiating elements are capacitively coupled to each other with through a gap in between them. This double flared geometry provides the bunny-ear antenna with a lower profile and stronger immunity to scanning blindness. Bunny-ear antennas require parallel strip-lines as an input feed and, if fed by coaxial lines, Baluns from the coaxial line to the strip-line become necessary. As a result, the operational bandwidth is directly constrained by the performance of the Baluns employed in the array.

Most of these arrays require differentiate feed, recently, a new type of UWB antenna arrays, planar ultrawideband modular antenna (PUMA) array, are developed by using an unbalanced 50 Ohms coaxial as a feed to significantly simply the antenna feed. The potential common mode generated by unbalanced feed in a conventional UWB array are suppressed or shifted out of the interested frequency band by introducing a shorting pins to reduce the cavity size. Up to 6:1 bandwidth of PUMA arrays have been developed. The idea of FUSE array is inherited from the PUMA. In the FUSE design, an inter-cardinal post is inserted in between the radiating elements and capacitively couple with the adjacent radiating arms. The post is shorted to the ground plane to reduce the resonant cavity size. Low profile and UWB operational are demonstrated. This design shows bandwidth of 7:1, scanning of ±45° with VSWR<2, and cross-polarization <−17 dB in all planes. More recently, the tightly coupled array (TCA) antenna has received tremendous interest as it may be implemented with a low profile, very light weight, and with good conformability. The TCA concept was originally derived from the current sheet antenna (CSA) proposed by Wheeler in 1965. A conceptual CSA can be realized by connected-dipole arrays, within which the adjacent dipoles are connected. CSAs take many different forms, however, the connected-dipole arrays theoretically possess lower cross polarization coupling, less confined reactive energy in the feed, and a broader impedance matching that can be independent of the scan angle. The planar connected-dipole array possess a lower cross-polarization coupling. In addition, the reactive energy contained in its feed network can be tuned so as to achieve broader matching independent of the scan angle.

Another choice is that of an interleaved-spiral array, which offers the widest operational bandwidth, however, it suffers from high cross-polarization coupling. A fragmented-antenna array uses a genetic algorithm (GA) to synthesize a broadband radiation aperture. And while it can be viewed as an infinite current sheet, where the current flows in a pattern defined path rather than two orthogonal directions. For this reason, fragmented arrays suffer from high cross-polarization coupling.

With all this being said, tightly coupled dipole antennas represent a relatively better candidate for most practical applications, where both ultra-wide bandwidth and low cross-polarization coupling are required. To increase the operational bandwidth of the connected dipole array in the presence of a ground plane, Professor Munk, et al., introduced strong capacitive coupling between the adjacent dipoles thus becoming a tightly coupled dipole array. The use of such strong capacitance attempts to cancel the inductance arising from the ground plane, thereby achieving a wider operational bandwidth of up to 4.5:1. To further improve the operational bandwidth, a superstrate and a resistive frequency selective surface (FSS) were applied to achieve a bandwidth up to 21:1.

Since the radiating elements in a TCA may take a symmetric form, such as dipoles and bowties, wideband balanced feeding is needed to excite an anti-symmetric current distribution, i.e., currents in the two dipole arms are equal in amplitude and 180° out of phase, within the antenna elements. An unbalanced feed will result in common mode excitation, impedance instability, and high cross-polarization coupling, thereby significantly degrading the operational bandwidth. In addition, the high input resistance of the TCA imposes another difficulty, namely to maintain a matched impedance with a conventional 50 coaxial line. As a result, a balanced-to-unbalanced transformer, i.e., Balun, as well as impedance transformer, is required for each radiating element. The use of these transformers, however, can impose additional restrictions on the performance of a TCA, such as the bandwidth, operational frequency, weight and profile, particularly at high operational frequencies. Alternatively, integrated Baluns can be incorporated into the design of the TCA, offering distinct features such as compact dimension, lower insertion loss, and higher operational frequency.

### SUMMARY

The inventive concept provides modular-based tightly coupled array (MTCA). The MTCA may take advantages of multilayer PCB (printed circuit board) manufacture, where antenna radiating elements are formed of metal layers of a PCB.

### BRIEF DESCRIPTION OF THE DRAWINGS

Embodiments of the inventive concept will be more clearly understood from the following detailed description taken in conjunction with the accompanying drawings in which:

FIG. 1 illustrates a historical development of UWB dense arrays;

FIG. 2A illustrates an example 3-layer unit cell;

FIGS. 2B, 2C and 2D illustrate details of an exemplary MTCA formed of a plurality of such unit cells;

FIGS. 3A and 3B illustrate exemplary configurations of top and bottom of the unit cell according to (ii) two layer design;

FIG. 3C illustrates a close up view of the integrated SMP connector to the PCB of a (ii) two layer design;

FIGS. 4A and 4B show the side view and top-down view of an exemplary array;

FIG. 4C shows a simulated return loss over a frequency band from 1 GHz to 7 GHz at different beam scanning angles;

FIG. 5 illustrates far field patterns of far field simulations;

FIG. 6A also shows an example of a unit cell according to a three layer design;

FIG. 6B illustrates an example (ii) two layer design unit cell;

FIG. 6C illustrates an example unit cell having a three layer design where shorting posts are integrated with the antenna on the PCB of the unit cell;

FIG. 7A provides an exploded view of a three layer design unit cell;

FIGS. 7B and 7C provide exploded views of a unit cell with a three layer design with integrated shorting posts;

FIG. 7D provides details of the layer build up of a unit cell with a three layer design with integrated shorting posts;

FIGS. 7E, 7F, and 7G provides exemplary details of the feeding architecture connecting a unit cell having a three layer design to radiating arms of the unit cell;

FIGS. 8A and 8B provide exemplary details of the feeding architecture connecting a unit cell having (ii) a two layer design to radiating arms of the unit cell; and

FIG. 9 illustrates an SMP connector and an array of SMP connectors as positioned on a ground plane (not shown) to connect to an array of unit cells.

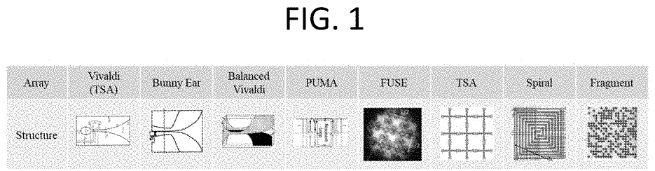

### DETAILED DESCRIPTION OF THE EMBODIMENTS

Hereinafter, embodiments of the inventive concept will be described in detail with reference to the accompanying drawings. A modular-based tightly coupled array (MTCA) disclosed herein may share advantages of a conventional FUSE antenna and the planar ultra-wideband modular antenna (PUMA) array, including use an unbalanced 50 Ohms coaxial connector to feed two radiating elements in the unit cell in the array as well as use of shorting pins, located between unit cells, to mitigate (e.g., attenuate or filter) the spurious radiation from unbalanced feeding transmission lines. The shorting post may be positioned between adjacent radiating elements. The shorting post is shorted to ground plane and strongly capacitively coupled with adjacent radiating arms. The shorting pin may reduce the cavity size by a factor of two, thereby shifting the resonant frequency of the common mode into much higher frequency range (e.g., higher than the operation frequencies of the antenna unit cell). To achieve an improved performance, integrated impedance transformer and Balun structure may also incorporated.

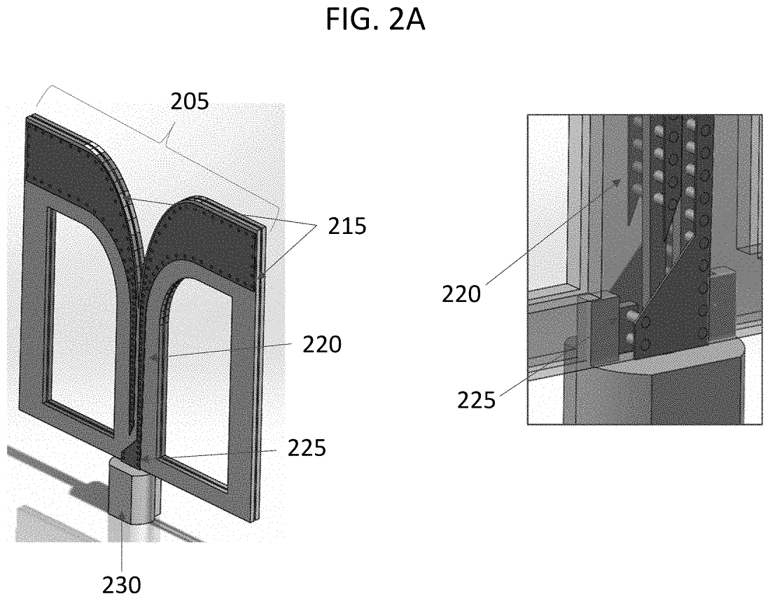

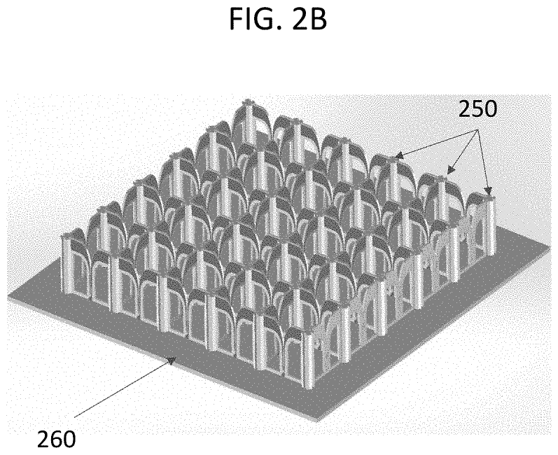

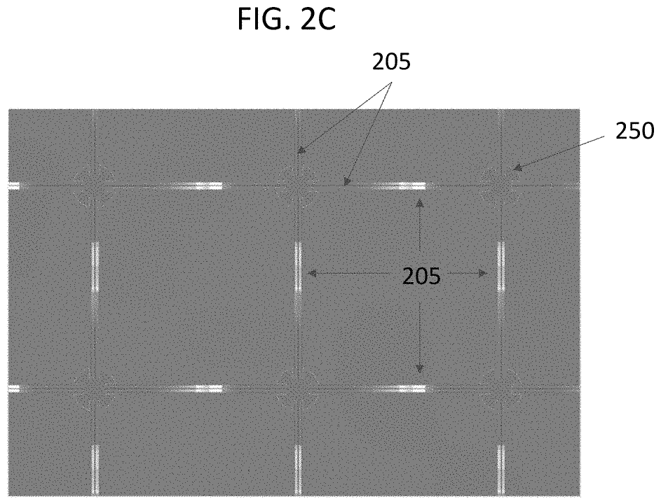

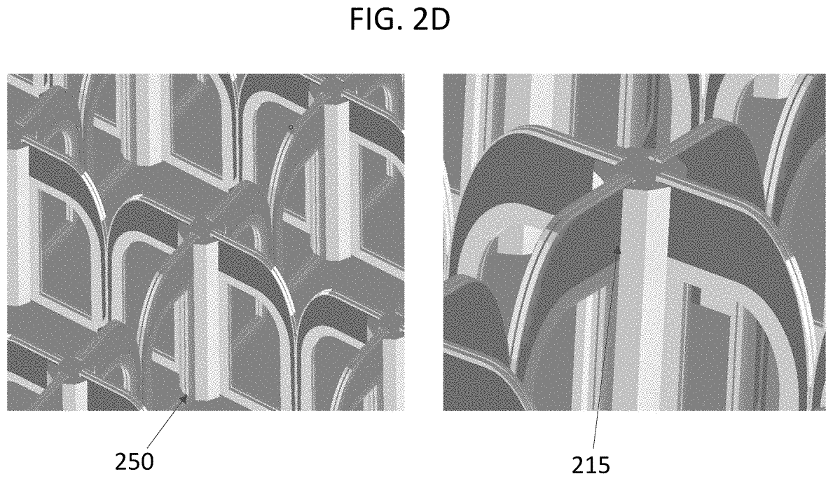

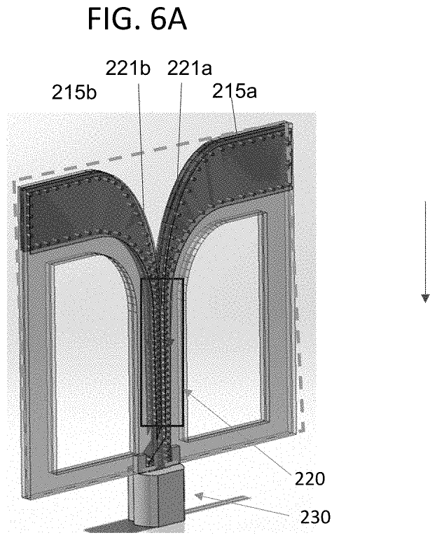

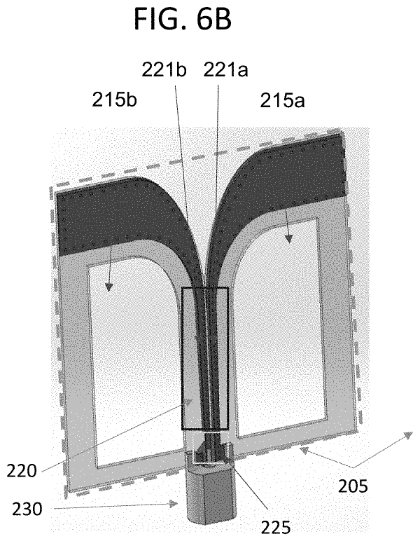

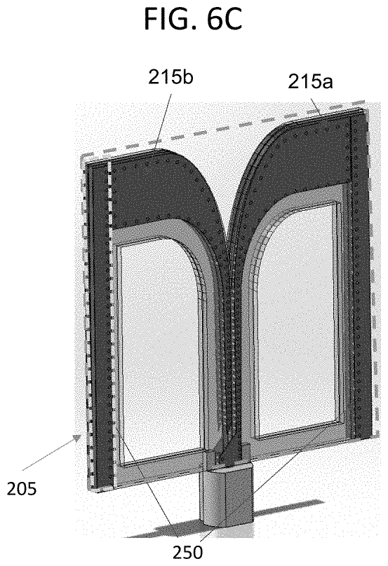

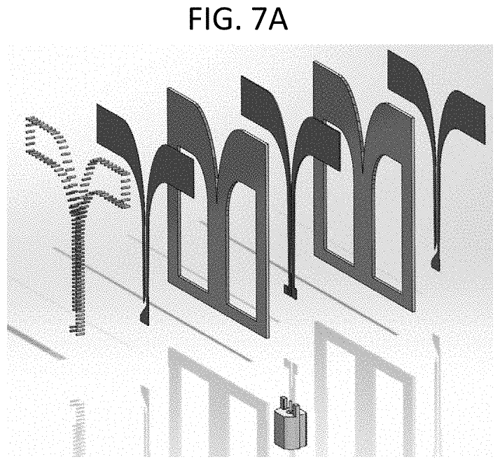

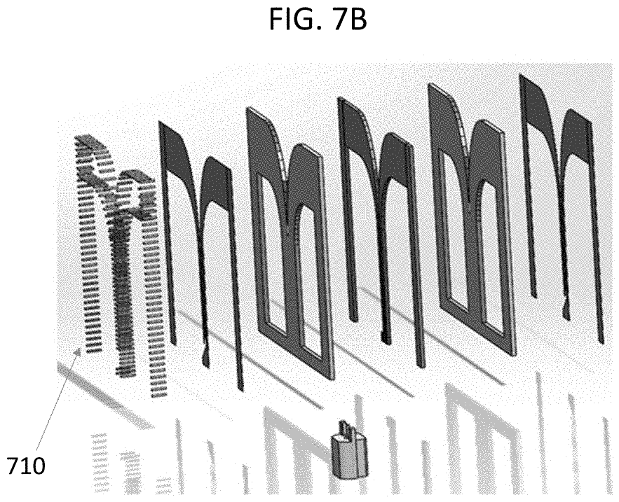

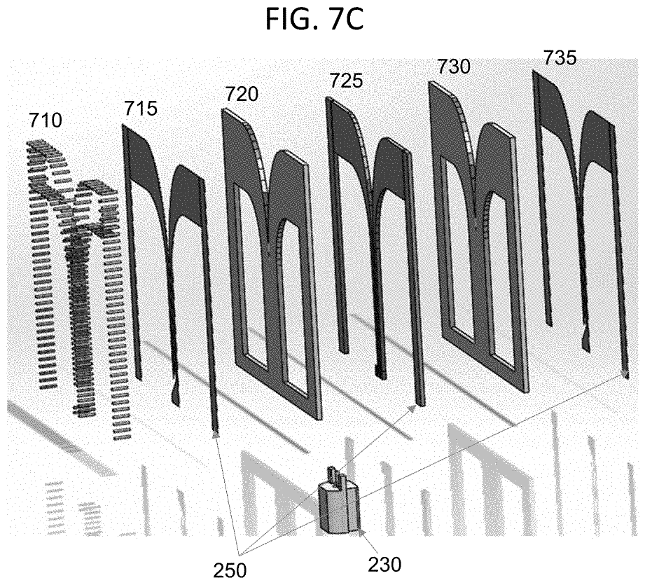

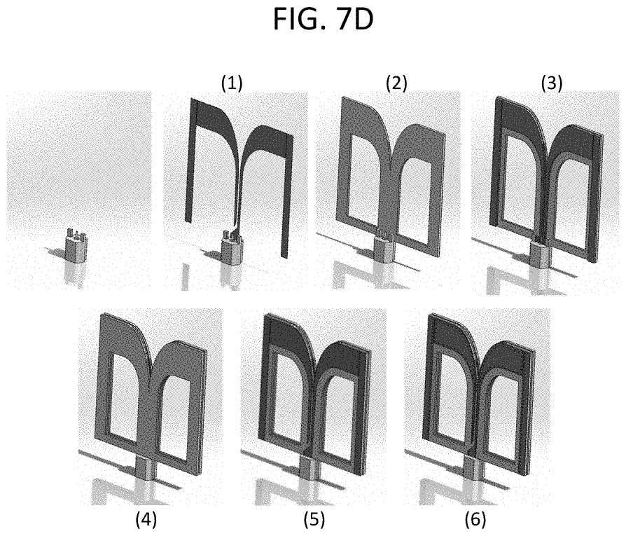

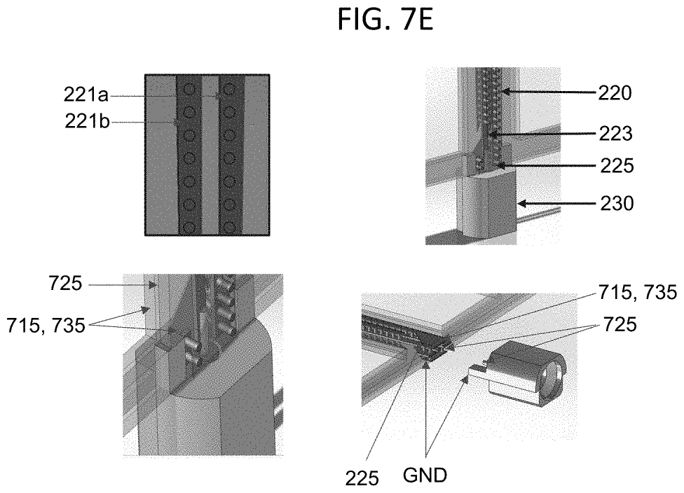

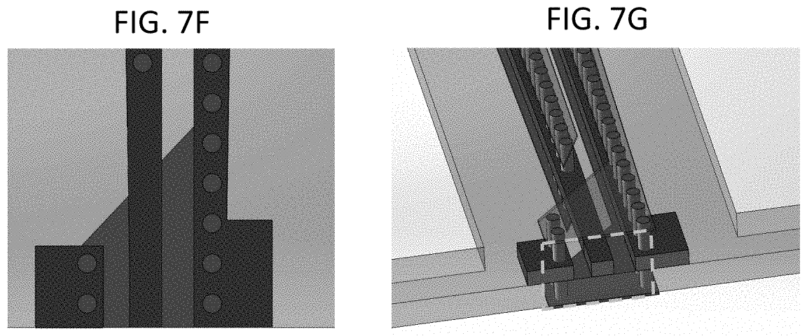

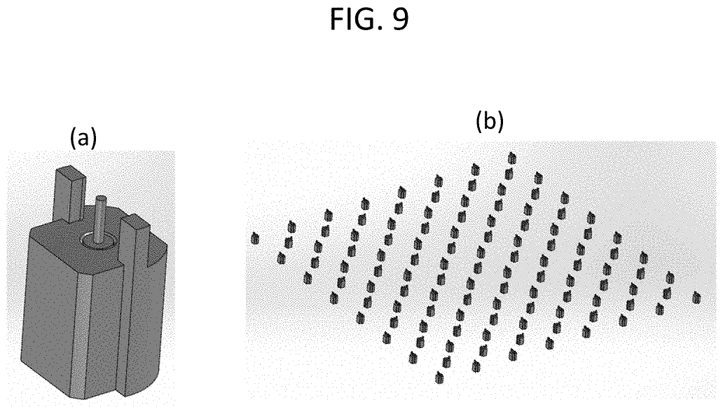

Modular-based tightly coupled array (MTCA) disclosed herein may take advantage of multilayer PCB (printed circuit board) manufacture. Two insulating substrates (e.g., polyimide) and three metallic layers are used in a (i) three layer design. The metallic layers of the PCB may be patterned with conventional PCB manufacturing techniques (e.g. as shown in the figures). An example 3-layer unit cell is shown in FIG. 2A, with FIGS. 2B, 2C and 2D illustrating details of an exemplary MTCA formed of a plurality of such unit cells. FIG. 6A also shows an example of a unit cell according to a (i) three layer design, with FIG. 7A providing an exploded view of such (i) three layer design unit cell. Unit cells described herein may each form an antenna element of the MTCA and be formed of two radiating arms of the antenna element. Unit cells described herein may also be referred to as antenna unit cells. In the design, the shorting posts may be formed of metal as rods or pillars, with four slots may be machined on the ground base (e.g., a conductive plate or metal substrate forming a ground plane of the MTCA). The metallic shorting posts may thus physically contact an electrically connect to the ground plane. The modular-based radiating elements are inserted into the slots in adjacent ones of the shorting posts. Near the unit cell edge of each unit cell, the solder screen are purposely patterned to provide electrical isolation between the shorting post and radiating antenna arms. As a result, a dielectric gap formed between the radiating arm and corresponding shorting post establish a strong capacitance between the shorting post and radiating arm. In addition, three stacked metallic layers and conductive through-vias can be used to form a substrate integrated coaxial as part of the PCB unit cell that is capable of direction integration with the (e.g., plugged into) SMP connectors (small miniaturized push-on connectors which may plug to a unit cell and maintain a connection via friction). FIG. 9 illustrates an SMP connector and an array of SMP connectors as positioned on a ground plane (not shown) to connect to an array of unit cells. The use of the SMP connector helps to ease the feeding circuits. The electrodes can be optimized to realize the impedance transition from the coaxial connector to a parallel strip line feeding the radiating element of the antenna. Moreover, by virtue of the PCB manufacture the outlines of the radiating element can be accurately defined. In doing so, unwanted substrate materials can be removed to improve the antenna radiation efficiency and broaden impedance bandwidth. A 2D dual linear polarization array, as shown in FIG. 2B, can be formed by populating the radiating elements in the 2D grid.

Referring to FIG. 2A, an antenna PCB 205 may include antenna radiating arms 215, a parallel stripline 220, a square coax 225, and an SMP connector 230. In some embodiments, the square coax 225 may be, alternatively, a microstrip or a stripline. As shown in FIG. 2B, a plurality of antennas (each formed on an antenna PCB 205) may be connected to corresponding SMP connectors 230. The SMP connectors 230 may extend through holes formed in a ground plane 260. The ground plane 260 may be a conductive metal substrate. Ends of the antenna arms may be capacitively coupled to the shorting posts 250. In FIG. 2C, which is a top down view, antenna PCBs 205 may be inserted into slots of the shorting posts 250. In some embodiments, antenna arms 215 and shorting posts 250 may be separated by a small gap (such as, for example, air or other dielectric) to provide strong capacitive coupling between the antenna arms 215 and the shorting posts 250. As illustrated in FIG. 2D, the shorting posts 250 may be electrically shorted to the ground plane 260. In addition, FIG. 2D illustrates that the antenna arms 215 may be capacitively coupled to the shorting posts 250, with a small gap (such as, for example, air or other dielectric) between the antenna arms 215 and the shorting posts 250 to provide an RF signal path from the antenna arms 215 to the ground plane 260 for certain RF frequencies.

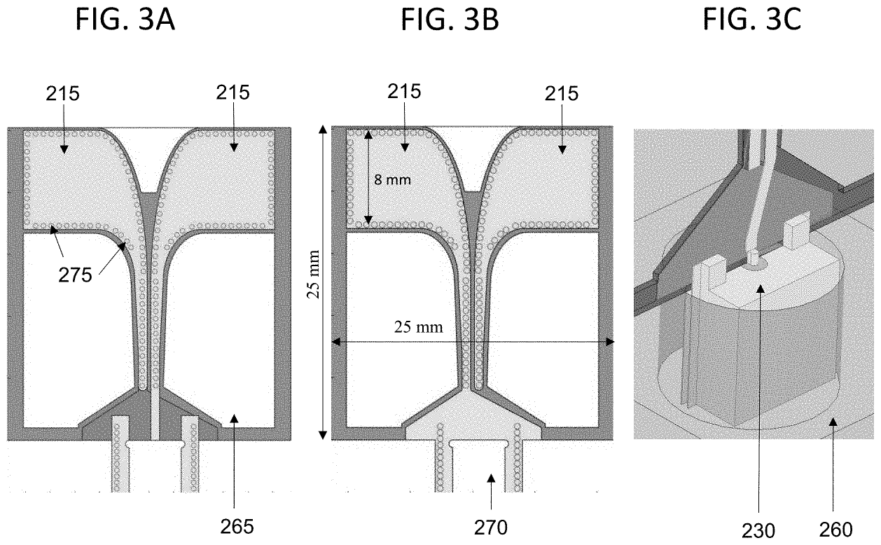

FIGS. 3A, 3B, and 3C illustrate a two layer design in which each of the radiating arms 215 of the antenna may have a length of one half of the wavelength of center operational RF frequency of antenna, and upper portions of the radiating arms 215 may be spaced apart from the ground plane 260 by about a wavelength of the center operational RF frequency of antenna. FIGS. 3A, 3B, and 3C further illustrate an FR4 substrate 265, an SMP mount area 270, and vias 275. In FIGS. 3A, 3B, and 3C, the radiating arms 215 may be copper arms.

The shorting posts 250 are realized by machining four trenches from a circular or square cylinder in two orthogonal directions. The machined post has a same height as the unit cell. The top and bottom sides of the post are tapped for mounting to the ground plane 260. The orange contours in FIG. 3C shows the cross section of the post. The trench has a same width as the PCB board thickness, allowing the board to tightly fit into the trenches. Since the solder screen is applied to the edges of the PCB to provide additional isolation between the PCB and metallic post. The posts are arranged into the 2D grids to form a 2D phased array. The modular-based unit cells can be applied into two orthogonal directions to generate a two-dimensional dual linearly polarized phased array. A close view around a shorting pin are shown in FIG. 3D. Four unit cells are slide into the trenches of the posts, in which the narrow gaps between the posts and the PCB unit cells produce a strong capacitive coupling. As a result, the strong coupling allows direct short from the radiating elements to the ground through the shorting posts 250. In doing so, the resonating loop length can be significantly reduced, completely shifting the resonant frequencies out of the interested frequency range.

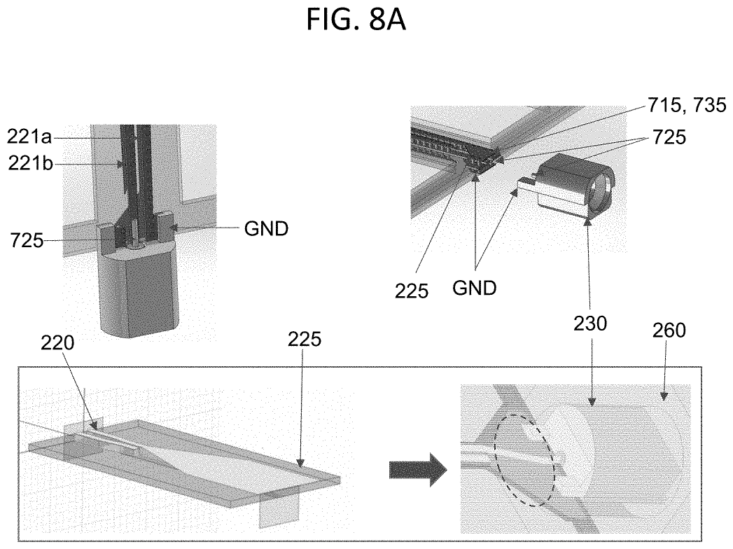

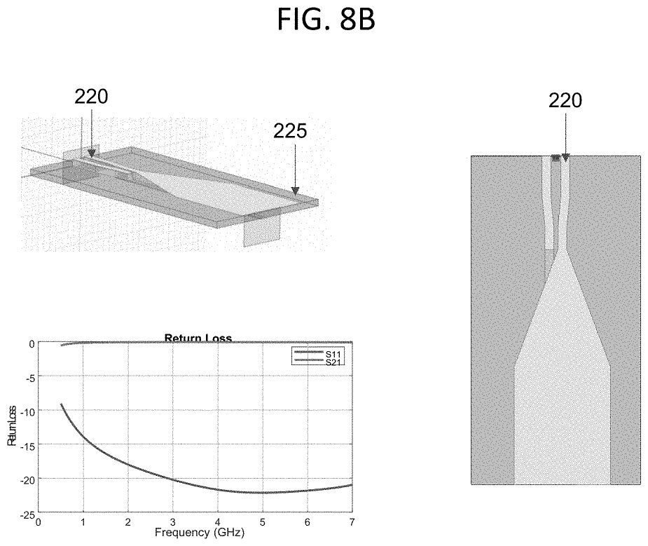

The multi-stacked PCB design discussed above can be simplified to a (ii) two-layer PCB phased array design. FIG. 6B illustrates an example (ii) two layer design unit cell comprising one RF insulative substrate (e.g., polyimide) and two copper arms formed on each side of the RF insulative substrate (forming radiating elements of an antenna of a unit cell). Exemplary configurations of top and bottom of the unit cell according to (ii) two layer design are shown in FIGS. 3A and 3B). FIGS. 8A and 8B provide exemplary details of the feeding architecture (or RF feed) connecting a unit cell having (ii) a two layer design to radiating arms 215 of the unit cell.

The copper arms are electrically shorted by conductive through vias. A plurality of conductive vias may be formed along the perimeter of the radiating arms 215 and RF feeds (microstrip line or parallel stripline 220) with regular spacing. At the base of the unit cell, a compact transition from a microstrip line to a parallel stripline 220 is incorporated. At the bottom side of the PCB, the ground plane 260 is tapered and connected to one of the radiating arms 215. In addition, the base of the PCB unit cell is designed to have a cutout to fit the SMP connector 230. A close up view of the integrated SMP connector 230 to the PCB of a (ii) two layer design is shown in FIG. 3C. Beneath the antenna is a metallic ground plane 260 with a special cutout for the SMP connector 230 to extend through the ground plane 260 and connect to the unit cell via the feeding architecture of the unit cell (here, an RF feed formed of a microstrip line merged/connected with a parallel stripline 220).

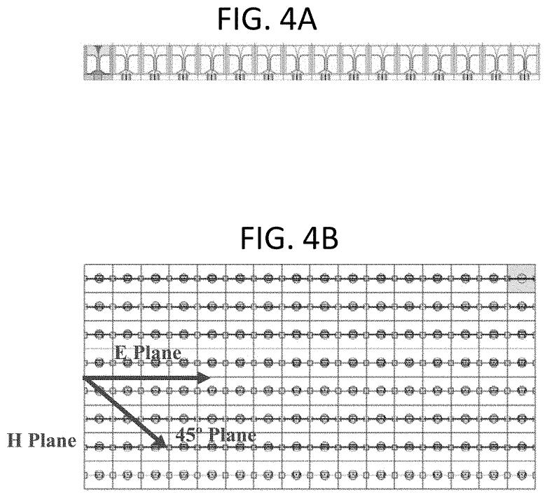

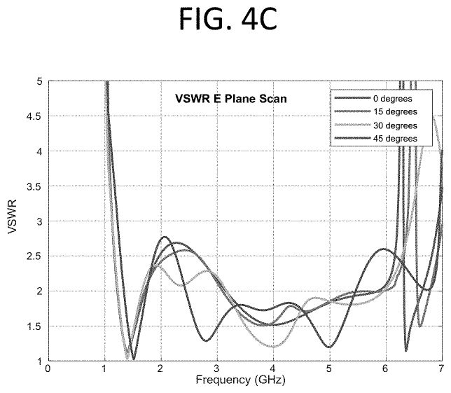

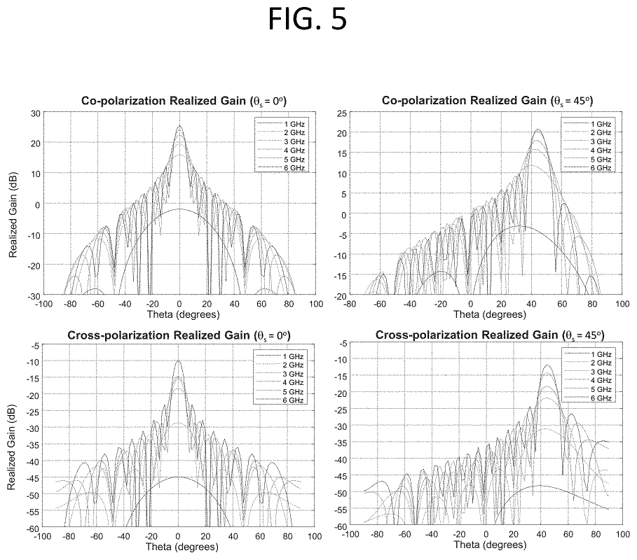

FIGS. 4A and 4B respectively show the side view and top-down view of an exemplary array. As an example, the array antenna may have an operate in an radio frequency (RF) range of 1 GHz to 6 GHz. Corresponding exemplary unit cell dimensions are shown in FIG. 3B, corresponding to half-wavelength at the highest operational frequency of 25 GHz. As a result, the grating lobes over the interested frequency can be completed suppressed. FIG. 4C shows a simulated return loss over a frequency band from 1 GHz to 7 GHz at different beam scanning angles of 0, 15°, 30°, and 45°, respectively. Within the frequency range, a resonant frequency at slightly higher than 6 GHz can be observed. Also, as seen from the plots, as the beam steers away from the broadside to 45°, a resonant frequency shifts towards to lower frequency. At the different steering angles, over the frequency band of 1 GHz to 6 GHz the simulated return loss is less than 2.5, indicating ultra-wideband operation of the proposed phased array antenna.

In the simulation, a 16×8 single linearly polarized array antenna was simulated. To demonstrate the beam scanning capabilities, the realized gain patterns are simulated over the frequency band of 1 GHz to 6 GHz. Far field simulations were carried out to study the proposed design. Each study consists of a scanning the steering beam of 0° and 45° in the E-plane. Both co-polarization and cross-polarization far field patterns are shown in FIG. 5. In the case of the broadside radiation, the peak realized gain of the array has a gain of 25 dBi in co-polarization, about 35 dB higher than that of cross-polarization. When the beam steers away to 45°, the peak gain drops slightly due to the roll-off of single unit cell radiation pattern. The cross-polarization also maintains less than −35 dB compared with the co-polarization.

FIG. 6A also shows an example of a unit cell according to a three layer design; FIG. 6B illustrates an example two layer design unit cell; and FIG. 6C illustrates an example unit cell having a three layer design where shorting posts are integrated with the antenna on the PCB of the unit cell. Each of FIGS. 6A, 6B, and 6C illustrate a right antenna arm 215a, a left antenna arm 215b, a parallel stripline 220, a right electrode 221a of the parallel stripline 220, a left electrode 221b of the parallel stripline 220, a microstrip line 225, an SMP connector 230, and shorting posts 250 integrated with the antenna on the antenna PCB 205.

In FIG. 6A, the feed is provided through the SMP connector 230 to a square coaxial/stripline and to the parallel stripline 220, connecting to shorting posts 250 at vertical edges of the PCB 205. In FIG. 6B, the feed is provided through the SMP connector 230 to microstrip line 225 and to the parallel stripline 220, connecting to shorting posts 250 at vertical edges of PCB 205.

FIG. 6C illustrates an example unit cell having (i) a three layer design where (iii) shorting posts 250 are integrated with the antenna on the PCB 205 of the unit cell. A small gap is provided between the shorting posts 250 and the antenna radiating arms 215 of the unit cell. In FIG. 6B, the shorting posts 250 are spaced apart from antenna arms 215 to capacitively couple with the antenna arms 215. Integrated shorting posts 250 may be used with either three layer design or two layer design

FIG. 7A provides an exploded view of a three layer design unit cell. The three layer design of FIG. 7A may be formed by stacking two double-sided laminated PCBs (i.e., two 2-metal layer PCBs) where the inner metal layer shown above is formed by a metal layer of each of the different 2-layer PCBs (being mirror images of each other) that are placed face-to-face with each other.

FIGS. 7B and 7C provide exploded views of a unit cell with (i) such a three layer design with (iii) integrated shorting posts 250. For example, FIG. 7B is an exploded view of a unit cell of integrated shorting post design (three metal layer design with integrated shorting posts on antenna PCB). In FIG. 7B, all the conductive vias 710 extend fully through all layers of the antenna PCB (thereby connecting metal of the top, center and/or bottom electrodes formed within a via path). The vias 710 act to provide thicker (the dimension perpendicular to PCB) metal conductors to provide thicker parallel stripline electrodes and antenna arms.

FIG. 7C is an exploded view of a unit cell (three metal layer design with shorting posts integrated with antenna PCB, i.e., shorting posts formed as part of the PCB). In FIG. 7C, the three layer shorting posts 250 are connected by vias 710. As shown in FIG. 7C, the unit cell may include vias 710, a top electrode 715, a second substrate 720, a center electrode 725, a first substrate 730, a bottom electrode 735, and an SMP connector 230. The top electrode 715, center electrode 725, and bottom electrode 735 may form the three layer shorting post 250.

FIG. 7D provides details of the layer build up of a unit cell with (i) such a three layer design with (iii) integrated shorting posts 250. The antenna PCB 205 formed separately from SMP connector 230 and later connected (e.g., soldered) to the SMP connector 230. As shown in FIG. 7D, (1) a first PCB metal layer pattern is provided, (2) a first PCB insulating is provided, (3) a second (internal) PCB metal layer pattern is provided, (4) a second PCB insulating layer is provided, (5) a third PCB metal layer pattern is provided, and (6) metal vias are added to connect metal layers.

FIGS. 7E, 7F and 7G provides exemplary details of the feeding architecture connecting a unit cell having (i) a three layer design to radiating arms 215 of the unit cell.

In FIG. 7E, right and left electrodes 215a and 215b of parallel stripline each formed from three metal strips (patterned metal strips in all three metal layers of PCB) that are connected together by through vias. The EM field confined mainly between the two electrodes of the parallel stripline. The structure is shown in semitransparent for easy visualization. The center electrode 725 of the SMP is connected by a metal strip (of second PCB metal layer) sandwiched between outer electrodes 715, 735 (first and third PCB metal layers) and connects center electrode 725 of the SMP to the left electrode of the parallel stripline). The outer electrodes 715, 735 (formed by first and third metal layer of PCB) are electrically connected together through the vias 710, and also electrically connected to the case of the SMP (or ground). Tapering structures of outer electrodes 715, 735 provide mode conversion from a square coaxial 225 to a parallel stripline 220. A circular SMP 230 is connected to square coaxial connector 225, which may be the termination of square coaxial transmission line formed by side edge of PCB. At the base of the unit cell, a compact transition 223 from the square coax 225 to a parallel stripline 220 may be incorporated.

FIG. 7F is a top down view showing the transition 223 of the square coaxial line 225 (bottom) to the parallel transmission line 220 (top). FIG. 7G illustrates the parallel transmission line connection to the antenna arms 215, and the square coaxial line 225 connection to the SMP 230.

FIGS. 8A and 8B provide exemplary details of the feeding architecture connecting a unit cell having (ii) a two layer design to radiating arms of the unit cell. In FIGS. 8A and 8B, right and left electrodes 221a and 221b of the parallel stripline 220 may each be formed from two metal strips (patterned metal strips in the two metal layers of antenna PCB) that are connected together by metal vias. The EM field confined mainly in between the two electrodes 221a and 221b of the parallel stripline 220. The center electrode 725 of the SMP is connected to the left electrode 221b of the parallel stripline 220. The case of the SMP (RF ground) is connected to the right electrode 221a of the parallel stripline 220 by patterned metal of the two metal layers of the PCB, one of which tapers) which are connected together with metal vias 710. Tapering structures provide mode conversion from a microstrip 225 to the parallel stripline 220. The circular SMP connector 230 is connected to the microstrip line 225.

FIG. 9 illustrates (a) a single SMP connector 230 and (2) an array of SMP connectors 230 as positioned on a ground plane (not shown) to connect to an array of unit cells.

While the inventive concept has been particularly shown and described with reference to embodiments thereof, it will be understood that various changes in form and details may be made therein without departing from the spirit and scope of the following claims.

What is claimed is:

1. A modular-based tightly coupled array comprising:
a plurality of antenna unit cells, each antenna unit cell comprising a pair of radiating arms and a connected RF feed configured to feed an RF signal to the pair of radiating arms, pair of radiating arms and RF feed of each antenna unit cell integrated as part of a corresponding printed circuit board (PCB);
a conductive ground plane;
a plurality of RF connectors mounted to the conductive ground plane, each connected to a corresponding antenna unit cell to provide the RF signal to the RF feed.

2. The modular-based tightly coupled array of claim 1, further comprising a plurality of shorting posts vertically extending from and electrically connected to the ground plane, wherein radiating arms of the antenna unit cells are capacitively coupled to corresponding shorting posts.

3. The modular-based tightly coupled array of claim 2,
wherein the shorting posts are metal rods extending from and physically contacting the ground plane, and
wherein the antenna unit cells are inserted into slots formed within adjacent shorting posts.

4. The modular-based tightly coupled array of claim 2, wherein each of the antenna unit cells is integrated with corresponding shorting posts on a corresponding PCB, where each radiating arms is spaced apart from a corresponding shorting post.

5. The modular-based tightly coupled array of claim 1, wherein the radiating arms of each unit cell are formed of three layers of metal of the PCB connected together by a plurality of conductive vias.

6. The modular-based tightly coupled array of claim 1, wherein the radiating arms of each unit cell are formed of two layers of metal of the PCB connected together by a plurality of conductive vias.
